(19) United States
(12) Patent Application Publication
(10) Pub. No.: US 2013/0142007 A1
(43) Pub. Date: Jun. 6, 2013

(54) Injector for a Granular Solid

(71) Applicant: BASF SE, Ludwigshafen (DE)

(72) Inventors: Oskar Stephan, Hockenheim (DE); Reiner Witt, St. Leon-Rot (DE); Ulrich Schroeder, Frankenthal (DE); John Joseph Louden, Manchester (GB)

(73) Assignee: BASF SE, Ludwigshafen (DE)

(21) Appl. No.: 13/677,468

(22) Filed: Nov. 15, 2012

Related U.S. Application Data
(60) Provisional application No. 61/560,310, filed on Nov. 16, 2011.

(30) Foreign Application Priority Data
Nov. 16, 2011 (EP) 11189340.0

(51) Int. Cl. B01F 15/02

(52) U.S. Cl. CPC B01F 15/0238
USPC 366/163.1

(57) ABSTRACT

The invention relates to an injector (21) for the addition of a granular solid to a mixing chamber, comprising a central pipe (3) for the addition of the granular solid, an addition apparatus (5) which surrounds the central pipe (3) and is intended for the addition of a propellant gas, wherein the central pipe (3) and the addition apparatus (5) which surrounds the central pipe (3) form an annular gap (9) at the end of the central pipe (3), and also a mixing section (11) with a constant cross section, which adjoins the annular gap (9), and a pipe portion (31) having an outlet opening subsequent to the mixing section (11). The pipe portion (31) having an outlet opening has a change in cross section from a circular inlet cross section to a non-circular outlet cross section of the outlet opening and is rotatable about a central axis.

The invention relates to an injector for the addition of a granular solid to a mixing chamber, comprising a central pipe for the addition of the granular solid, an addition apparatus which surrounds the central pipe and is intended for the addition of a propellant gas, wherein the central pipe and the addition apparatus which surrounds the central pipe form an annular gap at the end of the central pipe, and also a mixing section with a constant cross section, which adjoins the annular gap.

An injector for the addition of a granular solid is used, for example, for producing hygiene articles, for example diapers, sanitary napkins or similar products, which are intended to take up and envelop liquids.

To produce such products, superabsorbent particles are mixed together with fibers in a mixing chamber and applied as absorbent core to a backing. The superabsorbent particles are added in this case using an injector.

Depending on the product to be produced, it is necessary, for example, to produce absorbent cores of differing width. At present, this requires different injectors in each case. It is also only possible for absorbent cores having a uniform structure to be produced using current injectors. In particular, the absorbent cores which have been produced have a uniform width.

An injector for the addition of a granular solid is described, for example, in EP-A 0 271 258. To deliver granular or particulate material, the material is supplied via a central duct and air is blown in via an air gap, which surrounds the central duct. The air gap can be set by rotating the nozzle body.

Furthermore, a Venturi nozzle unit for supplying particulate material is also described in WO-A 2009/073849. The Venturi nozzle unit comprises an inner nozzle and an outer nozzle, which is formed concentrically around the inner nozzle. The inner nozzle has a conical shape and a flanged end portion, with a multiplicity of openings being formed in the flanged end portion. A propellant gas is supplied through the openings.

Furthermore, an addition apparatus for a solid particulate material is also described in WO-A 2010/031742. In this case, the injector is used for the addition of superabsorbent particles for producing hygiene products. The injector is adjusted via an inner pipe which is displaceable in the injector. By the displacement of the inner pipe, it is possible to set an annular gap through which a propellant gas flows. By setting the annular gap, it is possible to control the quantity of air which is supplied and therefore to set the particle stream.

The described system does not make it possible, however, to produce absorbent cores of differing width without replacing injector components or the entire injector. In particular, it is not possible to adapt the impact surfaces of the superabsorbent powder.

It is an object of the present invention to provide an injector which can be used to supply a granular solid, in particular a superabsorbent powder, for producing absorbent cores into a mixing chamber, in the case of which the impact surface of the superabsorbent powder can be adapted to the effective surface or to the geometry of the absorbent core.

The object is achieved by an injector for the addition of a granular solid to a mixing chamber, comprising a central pipe for the addition of the granular solid, an addition apparatus which surrounds the central pipe and is intended for the addition of a propellant gas, wherein the central pipe and the addition apparatus which surrounds the central pipe form an annular gap at the end of the central pipe, and also a mixing section with a constant cross section, which adjoins the annular gap, and a pipe portion having an outlet opening subsequent to the mixing section, wherein the pipe portion having an outlet opening has a change in cross section from a circular inlet cross section to a non-circular outlet cross section of the outlet opening and is rotatable about a central axis.

As a result of the non-circular outlet cross section, it is possible to vary the width of the emerging jet by rotating the pipe portion having an outlet opening.

The injector according to the invention is used, in particular, for the addition of superabsorbent powder into a mixing chamber for producing hygiene products, for example diapers or sanitary napkins. To produce the hygiene products, the superabsorbent powder is sprayed into a mixing chamber together with fibers, for example cotton fibers or synthetic fibers, where it is mixed with the fibers and applied to a backsheet. To apply the absorbent core, the backsheet is usually guided over a backing, which has depressions for the formation of the absorbent cores. A vacuum is applied to the inside of the backing, such that the backing material is sucked onto the backing. The region of the depressions for the absorbent cores is provided with holes, through which the superabsorbent powder and the fibers are then sucked for producing an absorbent core. After the absorbent cores have been produced, a layer of fabric is placed over the absorbent cores. This is followed by preparation to the desired products.

In order to produce absorbent cores of differing width by rotating the pipe portion having an outlet opening, or to set the particle distribution in the absorbent core, it is preferred for the outlet cross section of the pipe portion having an outlet opening to be oval or quadrangular, for example rectangular or square. In the case of a square outlet cross section, a different width is obtained by the length of one side of the square or upon rotation by 45° through the diagonal. It is particularly preferable for the outlet cross section of the pipe portion having an outlet opening to be rectangular.

The ratio of long side to short side in the case of a rectangular outlet cross section of the pipe portion having an outlet opening is preferably in the range of 1:1 to 10:1, more preferably in the range of 1:1 to 8:1, in particular in the range of 1:1 to 6:1. If the outlet cross section has the form of an ellipse, the ratio of the long half-axis to the short half-axis is preferably in the range of 1.1:1 to 10:1.

The ratio of long side to short side or long half-axis to short half-axis is also dependent, in particular, on the products to be produced using the injector.

In a preferred embodiment, the central pipe is axially displaceable in order to set the width of the annular gap through which the propellant gas is added. If the volumetric flow of the propellant gas is constant, this has the effect that the velocity is reduced if the size of the annular gap is increased and the velocity is increased if the size of the annular gap is reduced. It is thereby possible to set the quantity of particulate material which is added via the central pipe. By way of example, more powder is carried along in the event of a relatively high velocity of the propellant gas than in the event of a relatively low velocity.

In order to make it possible to set the annular gap as finely as possible, it is advantageous to mount the central pipe in the injector housing by a thread, and to screw the central pipe further into the thread or out of the thread in order to set the width of the annular gap. When the central pipe is screwed into the thread, the width of the annular gap is reduced, and the width of the annular gap is increased when the central pipe is screwed out. Depending on the pitch of the thread, it is thereby possible to very finely set the annular gap.

Furthermore, it is preferable for the diameter of the addition apparatus for the propellant gas which surrounds the central pipe to decrease toward the annular gap. By virtue of such a design, the annular gap is oriented axially to the main axis of the central pipe. It is thereby also possible to avoid a widening in the diameter from the central pipe to the mixing section which adjoins the central pipe. The diameter of the central pipe and the mixing section is preferably the same. A further effect of the decrease in the diameter of the addition apparatus for the propellant gas which surrounds the central pipe is that the propellant gas obtains an additional velocity component in the radial direction and therefore not only flows along the outer edge of the central pipe when it is added, but also is directed toward the axis of the central pipe. As a result, a uniform mixing of propellant gas and granular solid is obtained, and a uniform transport of the granular solid with the aid of the propellant gas is achieved.

As an alternative to a design in which the central pipe and the mixing section have the same diameter, it is also possible for the mixing section to have a slightly greater diameter than the central pipe or a slightly smaller diameter than the central pipe, for example. In any case, the annular gap should however be designed such that the propellant gas added has a velocity component toward the central axis of the central pipe. With reference to the diameter of the mixing section as compared with the diameter of the central pipe, it is possible to determine the velocity with which the granular solid enriched with propellant gas is transported. If the diameter of the mixing section is smaller than the diameter of the central pipe, the velocity is increased; as soon as the diameter of the mixing section is greater than the diameter of the central pipe, the mixture of propellant gas and granular solid travels at a lower velocity than in the case where the diameters are the same. However, it is preferable for the diameter of the central pipe and the diameter of the mixing section to be the same.

If the diameter of the mixing section is to be greater than the diameter of the central pipe, it is furthermore preferable for firstly the diameter of the addition apparatus which surrounds the central pipe to decrease toward the annular gap until said diameter is the same as the diameter of the central pipe, and a first diffuser adjoins the annular gap. The diameter is increased in the first diffuser, and the mixing section with a constant cross section then adjoins the first diffuser. In this case, the diameter of the mixing section is as large as the outlet cross section of the first diffuser. The use of the diffuser to increase the diameter uniformly reduces the velocity, and the flow rate with which the granular solid enriched with propellant gas flows can additionally be set by the opening angle of the diffuser. In particular, the use of the diffuser makes it possible to prevent the formation of dead zones, for example by vortex formation.

The propellant gas used is preferably a gas which is inert toward the granular solid used. Examples of suitable propellant gases are nitrogen and also air. It is particularly preferable for the propellant gas to be compressed air. To this end, the addition apparatus for the addition of the propellant gas is connected to a compressed air reservoir. The pressure of the compressed gas is preferably kept constant.

The injector according to the invention is used with particular preference for the addition of superabsorbent powder into a mixing chamber for producing hygiene products, for example diapers or sanitary napkins. To produce the hygiene products, it is conventional for the superabsorbent powder to be added with the aid of the injector and for a fibrous material to be added with the aid of a second injector. The fibrous material and the superabsorbent powder are mixed in a mixing chamber and introduced into a suitable mold for producing an absorbent core. To this end, a negative pressure is usually applied to the mold, and therefore the mixture of fibrous material and superabsorbent powder is sucked into the mold.

Examples of the invention are shown in the figures and are explained in more detail in the following description.

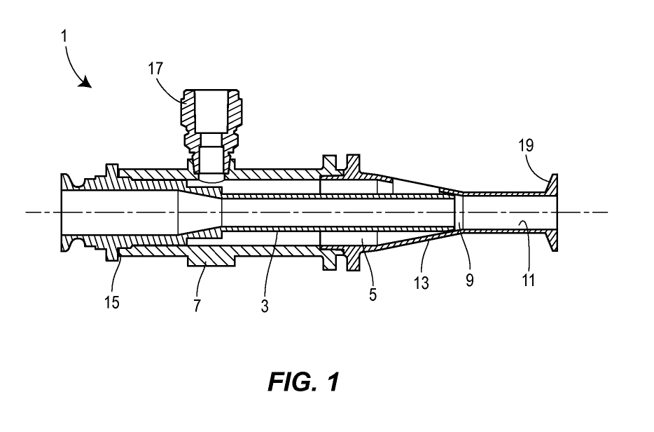

FIG. 1 shows a nozzle for the addition of a granular solid, comprising an axially displaceable central pipe and an adjoining mixing section,

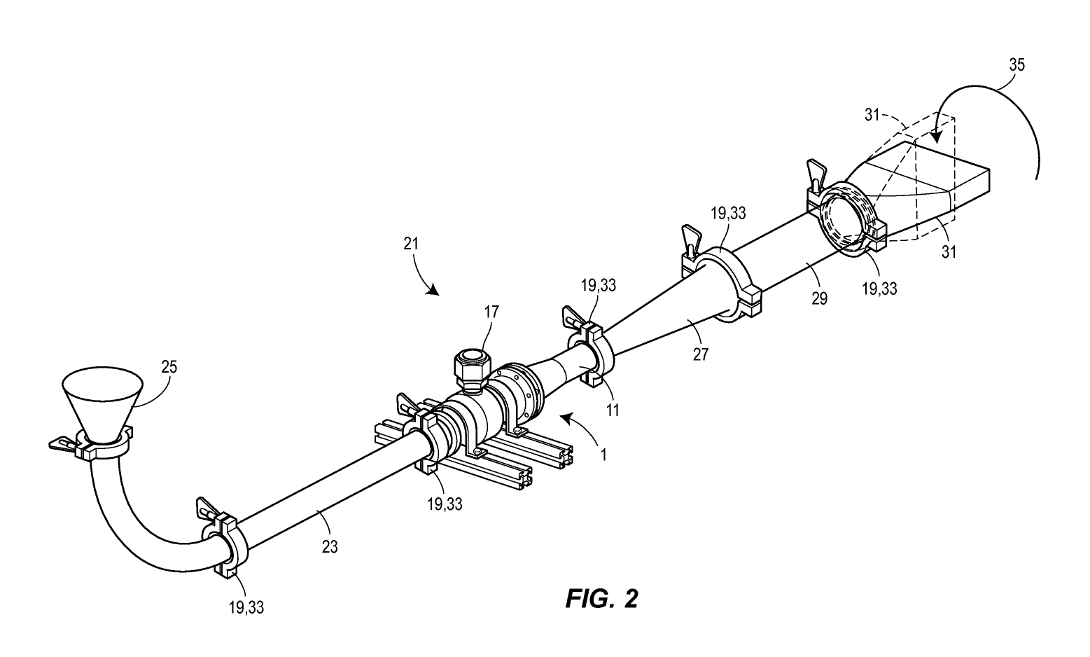

FIG. 2 is a three-dimensional illustration showing the injector according to the invention with a rotatable pipe portion having an outlet opening, and

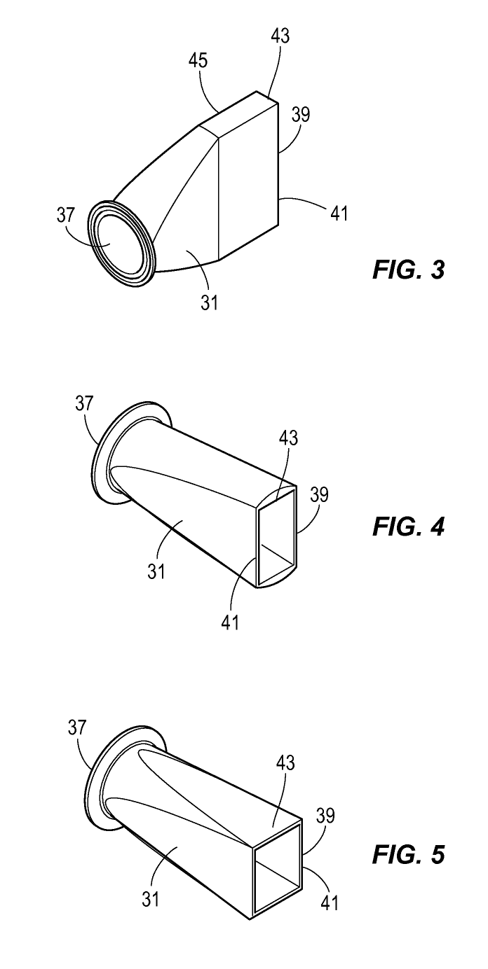

FIGS. 3 to 5 are three-dimensional illustrations showing various geometries for the pipe portion having an outlet opening.

FIG. 1 shows a nozzle for the addition of a granular solid, comprising an axially displaceable central pipe and a mixing section.

A mixing nozzle 1 is part of an injector for the addition of a granular solid to a mixing chamber. The mixing nozzle 1 comprises a central pipe 3, through which a granular solid is supplied. The central pipe 3 is surrounded by an addition apparatus 5 for the addition of a propellant gas. The outer boundary of the addition apparatus 5 is formed by an injector housing 7.

At the end of the central pipe 3, the central pipe 3 and the addition apparatus 5 which surrounds the central pipe 3 form an annular gap 9. The propellant gas added via the addition apparatus 5 flows through the annular gap 9 into a mixing section 11. The propellant gas flowing through the annular gap 9 into the mixing section 11 carries along granular solid from the central pipe 3, which is supplied in this way. In order to obtain uniform mixing of propellant gas, which is added through the annular gap 9, and granular solid, which is added through the central pipe 3, the addition apparatus 5 is designed such that the diameter thereof decreases toward the annular gap 9. To this end, the injector housing 7 which surrounds the addition apparatus 5 has a constriction in diameter 13. In the constriction in diameter 13, the diameter decreases continuously in the axial direction. At the end of the constriction in diameter 13, the diameter corresponds to the diameter of the central pipe 3. As a result of the constriction in diameter 13, the annular gap 9 is oriented in the axial direction. The orientation of the annular gap 9 provides the propellant gas supplied through the annular gap 9 with a velocity component in the radial direction. This makes it possible to uniformly mix propellant gas and granular solid. It is not just the case that the propellant gas flows along the wall of the mixing section 11.

In a preferred embodiment, the central pipe 3 is axially displaceable. The axial displaceability of the central pipe 3 makes it possible to set the width of the annular gap 9. This makes it possible to set the velocity with which the propellant gas is added through the annular gap 9. By setting the annular gap 9, it is possible, for example, to compensate for pressure variations in the propellant gas. As an alternative, it is also possible, by setting the annular gap 9, to modify the velocity and to control the quantity of granular solid added on the basis of the velocity.

In order to be able to axially displace the central pipe 3, it is possible, for example, to mount the central pipe 3 in the injector housing 7 by a thread 15. By rotating the central pipe 3, it is then displaced in the axial direction. When the central pipe 3 is screwed into the thread 15, the size of the annular gap 9 is reduced, and the size of the annular gap 9 is increased when the central pipe 3 is screwed out of the thread 15.

In order to be able to add the propellant gas, the addition apparatus 5, which surrounds the central pipe 3 as an annular duct, is connected to a connection 17. The propellant gas is supplied via the connection 17. To this end, the connection 17 is connected, for example, to a compressed air line. The propellant gas flows through the connection 17 into the addition apparatus 5. As a result of the annular configuration of the addition apparatus 5, the propellant gas is distributed uniformly around the central pipe 3 and then flows uniformly through the annular gap 9 into the mixing section 11.

In order to make it possible for the mixing section 11 to be connected to a pipe portion having an outlet opening, which is not shown in FIG. 1, the mixing section 11 is provided with a flange 19.

FIG. 2 shows an injector formed according to the invention for the addition of a granular solid to a mixing chamber, with a rotatable pipe portion having an outlet opening.

In addition to the mixing nozzle 1, an injector 21 comprises an addition apparatus 23 for granular solid. By way of example, the addition apparatus 23 comprises a funnel 25, through which the granular solid is supplied. The addition apparatus 23 does not have to comprise a funnel 25, however. It is also possible to connect the injector 21 directly to a reservoir for the granular solid, for example, and to add the granular solid, for example, through a lock, by way of example a rotary lock valve. It is also possible, by way of example, to provide a large charging hopper, which comprises a supply of granular solid.

The addition apparatus 23 for the granular solid is adjoined by the mixing nozzle 1 with the mixing section 11. In the embodiment shown here, the mixing section 11 is adjoined according to the invention by a first diffuser 27, which is followed by a second mixing section 29 with a larger diameter. The second mixing section 29 is adjoined by a pipe portion 31 having an outlet opening, which has a change in cross section. In the embodiment shown here, the cross section of the pipe portion 31 having an outlet opening changes from a circular inlet cross section to a rectangular outlet cross section.

The addition apparatus 23 for granular solid, the mixing nozzle 1, the mixing section 11, the first diffuser 27, the second mixing section 29 and the pipe portion 31 having an outlet opening are connected using suitable flanges 19, which are each connected using clamps 33.

According to the invention, the pipe portion 31 having an outlet opening is rotatable about the central axis of the injector 1. This is indicated here by an arrow 35. The pipe portion 31 having an outlet opening is shown in a first position with a solid line and in a second position, which is rotated by 90° with respect to the first position, with a dashed line.

By rotating the pipe portion 31 having an outlet opening, it is possible to set the width over which the granular solid is added.

The injector 21 as shown in FIG. 2 is suitable in particular for the addition of superabsorbent powder for producing hygiene products.

FIGS. 3 to 5 show, by way of example, three different geometries for the pipe portion 31 having an outlet opening. Here, the pipe portion 31 having an outlet opening has in each case a circular inlet cross section 37 and a quadrangular outlet cross section 39. On the inlet side, the pipe portion 31 having an outlet opening has the flange 19 with which the pipe portion 31 having an outlet opening is mounted on the second mixing section 29. The pipe portions 31 having an outlet opening which are shown in FIGS. 3 to 5 differ in terms of the geometry of the outlet cross section 39. In the embodiment shown in FIG. 3, for example, the outlet cross section is designed in the form of a rectangle having a long side 41 and a short side 43, the ratio of long side 41 to short side 43 being approximately 6:1. To provide greater uniformity of the flow, the actual pipe portion 31 having a changing cross section is further adjoined by an end piece 45 having a constant cross section.

In contrast to the embodiment shown in FIG. 3, the ratio of long side 41 to short side 43 in the embodiment shown in FIG. 4 is approximately 2:1, and that in the embodiment shown in FIG. 5 is approximately 1:1, i.e. the cross section is virtually square.

Depending on the different outlet cross sections 39, the nozzles can each be used in a manner specific to the product. It is therefore possible, for example, to select the longest possible long side 41 if very wide products are also to be produced.

### LIST OF REFERENCE NUMERALS

1 Mixing nozzle
3 Central pipe
5 Addition apparatus for propellant gas
7 Injector housing
9 Annular gap
11 Mixing section
13 Constriction in diameter
15 Thread
17 Connection
19 Flange
21 Injector
23 Addition apparatus for granular solid
25 Funnel
27 First diffuser
29 Second mixing section
31 Pipe portion having an outlet opening
33 Clamp
35 Rotation of the pipe portion 31 having an outlet opening
37 Inlet cross section
39 Outlet cross section
41 Long side
43 Short side
45 End piece

1. An injector for the addition of a granular solid to a mixing chamber, comprising a central pipe (3) for the addition of the granular solid, an addition apparatus (5) which surrounds the central pipe (3) and is intended for the addition of a propellant gas, wherein the central pipe (3) and the addition apparatus (5) which surrounds the central pipe (3) form an annular gap (9) at the end of the central pipe (3), and also a mixing section (11) with a constant cross section, which adjoins the annular gap (9), and a pipe portion (31) having an outlet opening subsequent to the mixing section, wherein the pipe portion (31) having an outlet opening has a change in cross section from a circular inlet cross section to a non-circular outlet cross section of the outlet opening and is rotatable about a central axis.

2. The apparatus according to claim 1, wherein the outlet cross section of the pipe portion (31) having an outlet opening is oval or quadrangular.

3. The apparatus according to claim 1, wherein the central pipe (3) is axially displaceable in order to set the width of the annular gap (9).

4. The apparatus according to claim 3, wherein the central pipe (3) is mounted in the injector housing (7) by a thread (15), and the central pipe (3) is screwed further into the thread (15) or screwed out of the thread (15) in order to set the width of the annular gap (9).

5. The apparatus according to claim 1, wherein the diameter of the addition apparatus (5) which surrounds the central pipe (3) decreases toward the annular gap (9).

6. The apparatus according to claim 1, wherein the diameter of the addition apparatus (5) which surrounds the central pipe (3) decreases to the diameter of the central pipe (3).

7. The apparatus according to claim 1, wherein the central pipe (3) and the mixing section (11) have the same diameter.

8. The apparatus according to claim 1, wherein a first diffuser (27) is arranged subsequent to the annular gap (9), and the mixing section (29) with a constant cross section adjoins the first diffuser (27).

9. The apparatus according to claim 1, wherein the addition apparatus (5) for the addition of a propellant gas is connected to a compressed air reservoir.

10. The apparatus according to claim 1 used for the addition of superabsorbent powder to a mixing chamber for preparing hygiene products.
